(19) United States
(12) Patent Application Publication
(10) Pub. No.: US 2023/0308770 A1
(43) Pub. Date: Sep. 28, 2023

(54) METHODS, APPARATUSES AND COMPUTER PROGRAM PRODUCTS FOR UTILIZING GESTURES AND EYE TRACKING INFORMATION TO FACILITATE CAMERA OPERATIONS ON ARTIFICIAL REALITY DEVICES

(71) Applicant: META PLATFORMS, INC., Menlo Park, CA (US)

(72) Inventors: Xiaoxing Li, Los Gatos, CA (US); Jun Hu, San Jose, CA (US); Yazhu Ling, San Jose, CA (US); Honghong Peng, Mountain View, CA (US); Shan Tong, Sunnyvale, CA (US); Gabriel Molina, Sunnyvale, CA (US)

(21) Appl. No.: 17/833,291

(22) Filed: Jun. 6, 2022

Related U.S. Application Data
(60) Provisional application No. 63/317,444, filed on Mar. 7, 2022.

(51) Int. Cl. H04N 5/235; G06F 3/01; G10L 15/22; G06V 40/20; G06V 10/22; G06V 10/25; G06T 7/80

(52) U.S. Cl. CPC H04N 5/2353; G06F 3/013; G06F 3/017; G06T 7/80; G06V 10/22; G06V 10/25; G06V 40/28; G10L 15/22; G06T 2207/30201; G10L 2015/223

(57) ABSTRACT

Systems and methods are provided for operating image modules via an artificial reality (AR) device. In various exemplary embodiments, an artificial reality device may initiate a first camera of the AR device to identify a picture region and may track at least one gaze via a second camera of the AR device or at least one gesture via the first camera. The AR device may be a head-mounted device, for example, including a plurality of inward and outward facing cameras. The AR device may determine a region of interest within the picture region based on the at least one tracked gaze or gesture and may focus on the region of interest via the first camera. The focusing operations may include at least one of an auto-exposure operation, an auto-focus operation, or a stabilizing operation.

### CROSS-REFERENCE TO RELATED APPLICATIONS

This application claims priority to U.S. Provisional Application No. 63/317,444, filed Mar. 7, 2022, entitled “Image Module and Camera Operations on Artificial Reality Devices,” which is incorporated by reference herein in its entirety.

### TECHNICAL FIELD

The present disclosure generally relates to systems and methods for operating imaging devices based on one or more detected user gestures and/or user information.

### BACKGROUND

Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. In this regard, AR, VR, MR, and hybrid reality devices often provide content through visual mechanisms, such as through a headset, e.g., glasses.

Many artificial reality devices utilize cameras to present information to a user and may execute various AR operations and simulations. Such operations may be extremely challenging to execute, since the AR devices may receive, incorporate, and accurately convey images in a manner that provides seamless and realistic output for users. For example, when capturing an image or executing operations based on user input, an AR device may often synchronize a user’s view with an image capturing module. Any discrepancies and uncertainties between the views may lead to erroneous image information that may affect any operations utilizing the image, and/or the user’s experience using the AR device. Accordingly, there is a need to operate image capturing modules accurately and efficiently on artificial reality devices.

### BRIEF SUMMARY

In meeting the described challenges, the present disclosure provides exemplary systems and methods for operating artificial reality devices. For instance, the exemplary embodiments may detect one or more user gestures to identify a region of interest by the user and may execute one or more operations on the artificial reality device.

In various exemplary embodiments, a device may include a first camera, a second camera configured to track at least one of a gaze or a gesture, a processor and a non-transitory memory including computer-executable instructions to be executed by the processor. The computer-executable instructions may cause the device to at least: initiate the first camera to identify a picture region; track the at least one gaze via the second camera or the gesture via the first camera; determine a region of interest within the picture region based on the at least one tracked gaze or gesture; and focus on the region of interest via the first camera. In some exemplary embodiments, the device may be an artificial reality device.

In one example embodiment, a device is provided. The device may include a plurality of cameras. The device may further include one or more processors and a memory including computer program code instructions. The memory and computer program code instructions are configured to, with at least one of the processors, cause the device to at least perform operations including initiating at least one camera of the plurality of cameras to capture a region of interest indicated in a viewpoint of the device. The memory and computer program code are also configured to, with the processor, cause the device to capture, by the at least one camera or another camera of the plurality of cameras, at least one gesture detected within the region of interest, or at least one gaze associated with the region of interest, to automatically focus on at least one area within the region of interest indicated within the viewpoint of the device. In some exemplary embodiments, the device may be an artificial reality device.

In another example embodiment, a computer program product is provided. The computer program product includes at least one computer-readable storage medium having computer-executable program code instructions stored therein. The computer-executable program code instructions may include program code instructions configured to initiate at least one camera of a plurality of cameras of a device to capture a region of interest indicated in a viewpoint of the device. The computer program product may further include program code instructions configured to capture, by the at least one camera or another camera of the plurality of cameras, at least one gesture detected within the region of interest, or at least one gaze associated with the region of interest, to automatically focus on at least one area within the region of interest indicated within the viewpoint of the device.

In yet some other exemplary embodiments, the focus operation may include applying at least one of: an auto-exposure operation, an auto-focus operation, a stabilizing operation, or any other camera control operation that may benefit from scene content awareness, such as a temporal smoothing operation. In the focus operation, the AR device may further capture an image of the picture region, and highlight the region of interest in the image. The focus operation may also determine a relationship between the at least one gaze or gesture and the picture region, identify the region of interest based on the relationship, and receive input indicative of a selection of the region of interest. In some exemplary embodiments, the relationship may identify at least one of an eye direction relative to the picture region or a gesture direction relative to the picture region. In additional exemplary embodiments, the input indicative of the selection may be a period of time when the at least one gaze or gesture is held. The period of time may be one second, or more or less time, depending on the configuration and settings of the AR device.

In various exemplary embodiments, the inputs indicative of a selection may be at least one of a verbal confirmation or a manual confirmation. The gesture may be a hand motion comprising at least one of a directional indication, a pinching indication, a framing indication. Some exemplary embodiments may comprise a plurality of cameras. A third camera, for example, may be configured to track at least one of a gaze or a gesture. Cameras may be head-mounted cameras, and AR devices in accordance with exemplary embodiments may comprise one or more outward facing cameras, and one or more inward facing cameras. In various exemplary embodiments, the artificial reality device may further comprise glasses, a headset, a display, a microphone, a speaker, and any of a combination of peripherals, and computing systems.

As described herein, various systems and methods may utilize a trained machine learning model to adapt to user actions and operation of an AR device. Gestures and/or attributes of gestures, for example, may be evaluated using machine learning models. User commands, as determined by the identified gestures, may initiate the focus operations of a region of interest.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1A illustrates an initial image from an artificial reality system in accordance with exemplary embodiments of the present disclosure.

FIG. 1B illustrates a focusing gesture for use with the artificial reality system in accordance with exemplary embodiments of the present disclosure.

FIG. 2A illustrates an image obtained by an image module in accordance with exemplary embodiments of the present disclosure.

FIG. 2B illustrates a focus adjustment on an image obtained by an image module in accordance with exemplary embodiments of the present disclosure.

FIG. 3A illustrates an initial image obtained by an image module in accordance with exemplary embodiments of the present disclosure.

FIG. 3B illustrates a gesture-based focus adjustment in accordance with exemplary embodiments of the present disclosure.

FIG. 4 illustrates an example image adjustment operation in accordance with exemplary embodiments of the present disclosure.

FIG. 5 illustrates a focusing operation in accordance with exemplary embodiments of the present disclosure.

FIG. 6 illustrates an artificial reality system comprising a headset, in accordance with exemplary embodiments of the present disclosure.

FIG. 7 is a diagram of an exemplary process in accordance with an exemplary embodiment of the present disclosure.

FIG. 8 illustrates a block diagram of an example device according to an exemplary embodiment of the present disclosure.

FIG. 9 illustrates a block diagram of an example computing system according to an exemplary embodiment of the present disclosure.

FIG. 10 illustrates a machine learning and training model in accordance with exemplary embodiments of the present disclosure.

FIG. 11 illustrates a computing system in accordance with exemplary embodiments of the present disclosure.

### DETAILED DESCRIPTION

The present disclosure can be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claimed subject matter.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

It is to be appreciated that certain features of the disclosed subject matter which are, for clarity, described herein in the context of separate embodiments, can also be provided in combination in a single embodiment. Conversely, various features of the disclosed subject matter that are, for brevity, described in the context of a single embodiment, can also be provided separately or in any sub-combination. Further, any reference to values stated in ranges includes each and every value within that range. Any documents cited herein are incorporated herein by reference in their entireties for any and all purposes.

In traditional image capturing operations, manual interaction with the imaging device may be required to capture the image and apply the desired settings to the image. For example, on a smartphone, a user typically taps the screen to auto-focus an image and selects a digital or physical button to capture an image. The exemplary embodiments of the present disclosure may eliminate the need for such manual interactions, and provides systems and methods for capturing images and otherwise interacting with the cameras and image-capturing devices associated with an AR device. As described herein, exemplary embodiments of the present disclosure may be headsets and/or head-worn devices comprising a plurality of imaging modules, such as outward-facing cameras and/or inward-facing cameras. In various exemplary embodiments, an AR device may comprise an inward-facing camera that may track a user’s eyes, as well as an outward-facing camera, which may capture views of the user’s surroundings, and may capture at least part of the scene that a user sees through the AR device.

In various exemplary embodiments, systems and methods may utilize one or more user gestures and operations to identify regions of interest, and may capture images focusing on such regions of interests.

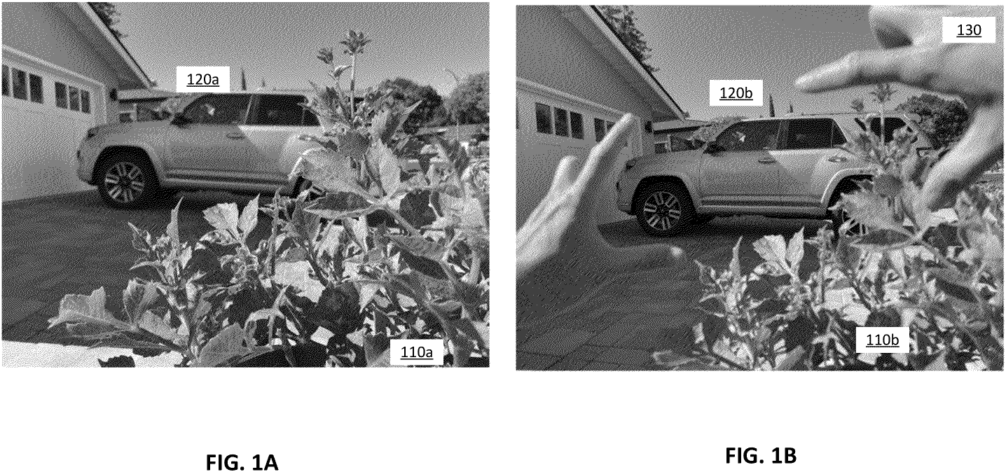

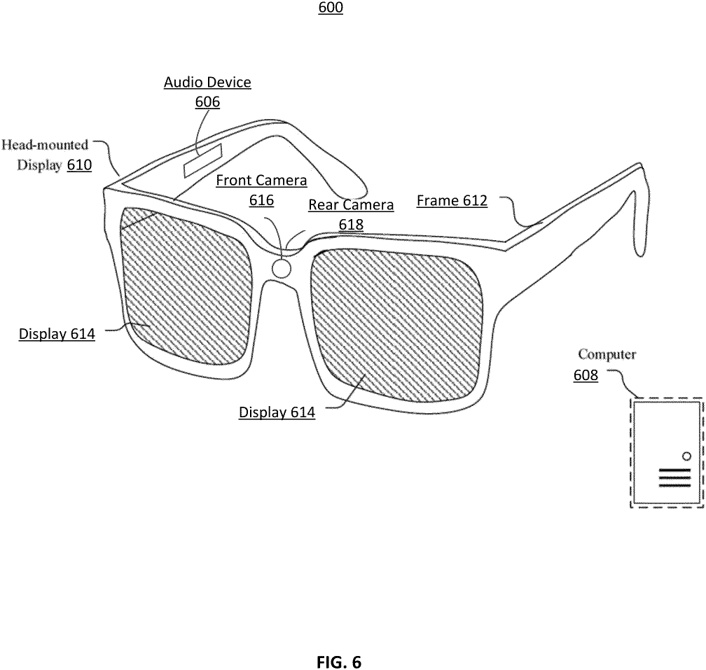

FIGS. 1A and 1B, for example, illustrate a gesture-based focusing operation in accordance with exemplary embodiments described herein. In FIG. 1A, which illustrates an initial image captured by an imaging module (e.g., imaging modules, front camera 616, rear camera 618 of FIG. 6), the closer object 110a, i.e., the plant, has been identified (for example by the imaging module) as the default focused object. The distant object 120a, i.e., the car, may not be in focus.

The imaging module may receive/detect information indicative of a gesture 130 to identify a desired region of interest. The gesture 130 in this example may be a framing gesture, wherein a user extends two fingers on each hand, e.g., the index finger and thumb, and frames the region of interest, i.e., distant object 120b. Based on the gesture 130, an AR device (e.g., AR system 600 of FIG. 6) may adjust its focus from the closer object to the distant object. As seen in FIG. 1B, the closer object 110b becomes unfocused, and the distant object 120b, which is framed by gesture 130, becomes the focused object.

In various exemplary embodiments gestures may comprise any of a plurality of actions, indications, movements, sounds, vibrations, or a combination thereof, in order to identify the desired region(s) of interest associated with an image(s).

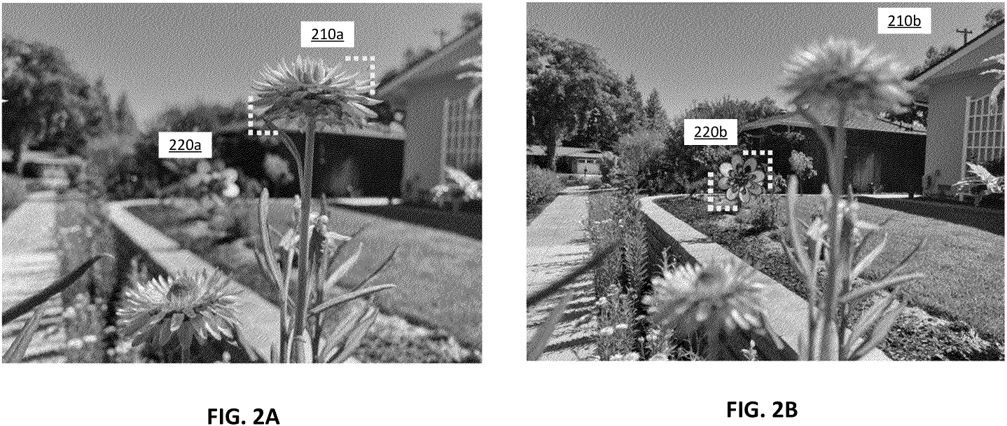

FIGS. 2A and 2B illustrate an alternate method for identifying a region of interest. As described herein, AR devices may comprise a plurality of cameras, including an inward-facing camera (e.g., rear camera 618 of FIG. 6). An inward-facing camera may track the eye movements of a user wearing the AR device, and may therefore provide important information into the user’s point of view and area of focus of the AR device. In some example embodiments, the AR device may utilize a camera module to track the user’s gaze, to identify the desired region of interest. The direction of the user’s gaze may identify the region of interest, and one or more focusing operations.

In such exemplary embodiments, the eye-tracking camera may be synchronized with a second camera that captures at least a part of the user’s view. As such, information received from the eye-tracking camera may inform where and/or what object(s) the user is looking at.

In various exemplary embodiments, when a user shifts his/her gaze, e.g., from one part of the scene to another, the user’s eyes may shift as well. Exemplary embodiments in accordance with the present disclosure may identify a relationship between the movement of the user’s gaze with a view captured by the second camera. For example, one or more machine learning, optimization and/or triangulation techniques may be utilized to determine a relationship between the camera position, the user’s eye position, eye direction, and the observed scene to determine a region towards which the user is looking. One or more machine learning techniques may be applied, as described herein, to tailor the relationships and predicted region of interest to the user’s particular gazing habits and/or adapt to adjustments from positions of the cameras.

As illustrated in FIG. 2A, for example, a first region of interest may focus on a closer object, e.g., flower 210a. In some exemplary embodiments, the initial focusing on flower 210a may be due to a default setting, an initial user gaze towards the object, an initial selection via an AR device/system, or any of a plurality of reasons. In FIG. 2A, the distant object, e.g., windmill 220a, may be initially out of focus.

In FIG. 2B, a change in the user’s gaze, captured by an imaging module of an AR device, may indicate a shift from the closer object, e.g., flower 210b, to the distant object 220b. The change in the user’s gaze may be due to movement of the user’s eye, which when synchronized with received outward-facing images, may indicate a shift in the user’s gaze. Accordingly, systems in accordance with the present disclosure may associate eye movements with a change in focus of the user and may use the eye movements to predict a region of interest to apply a focusing operation.

In exemplary embodiments, the focusing operation may assist with image-capturing operations, such as taking a picture. The operation may be, for example, an auto-exposure operation, an auto-focusing operation during image capture, a stabilizing operation and/or a camera control operation that may benefit from scene content awareness, such as a temporal smoothing operation, among others. In various exemplary embodiments, identification and focusing on a region(s) of interest may be associated with image capturing operations, such as in association with a camera function. In other exemplary embodiments, such operations may provide a real-time video feed showing a user’s view. The image may be displayed, for example, on the AR device, e.g., on a screen that forms a part of and/or is otherwise associated with an AR headset, or other local or remote display device.

In some exemplary embodiments, the length of time that a user’s gaze is on an object may trigger one or more operations of the imaging module and/or AR device. For example, information indicative of a user looking at an object for a predetermined period of time, e.g., 1 second, may trigger a focusing operation on the object. In some example embodiments, the period of time may be more or less than one second, and may be adjustable based on device settings, learned data regarding the user, and/or manually adjusted based on user preferences. It may be appreciated that systems and methods may not require a fixed time period to initiate a focusing operation based on a gaze, and that any of a plurality of adjustments, user settings, and preferences, may be implemented to identify, adjust, and adapt to the user, to optimally identify objects and/or regions of interest.

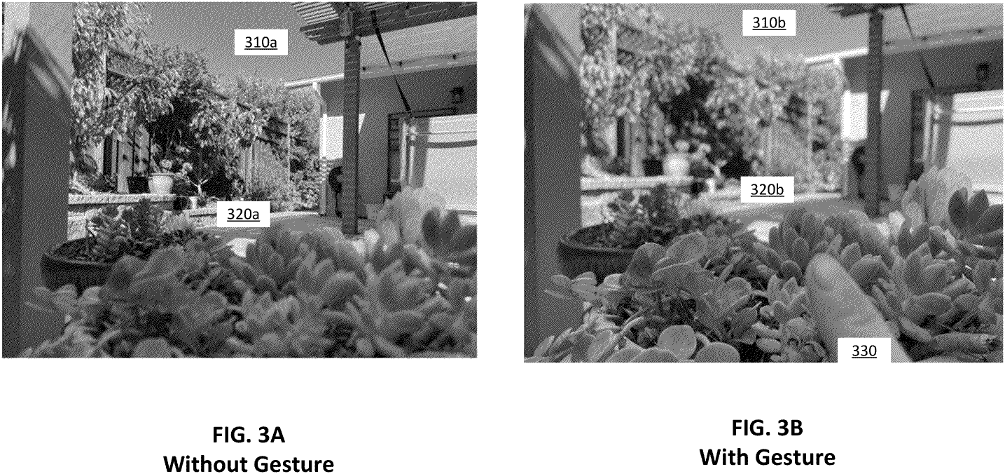

FIGS. 3A and 3B show another example of a focusing operation to identify an object of interest, in accordance with exemplary embodiments. Some AR image-capture scenes may comprise a plurality of objects, and certain gestures, for example the framing gesture, may encompass (e.g., capture of) more objects than are intended to be in a region of focus of an image. In this regard, other gestures, such as a pointing gesture 330 may be utilized to identify a desired object of interest.

In the example, FIG. 3A shows that the object of interest, e.g., plant 320a, is out of focus, and the distant objects 310a are initially the objects of focus. Gesture 330 may be utilized to identify that the plant 320b is the desired object of interest, and the imaging module may subsequently focus on plant 320b.

In these examples of FIGS. 3A and 3B, the scene captured by an AR device may align with the user’s point of view. The camera and/or imaging module (e.g., camera 616 of FIG. 6) may be outward-facing, as described herein, and may capture approximately the same field of view seen by the user of the AR device. As such, when a user gestures, e.g., points, towards an object of interest, the captured images from the imaging module may accurately identify where and/or what the user is gesturing towards, and may determine the object and/or region of interest for identification.

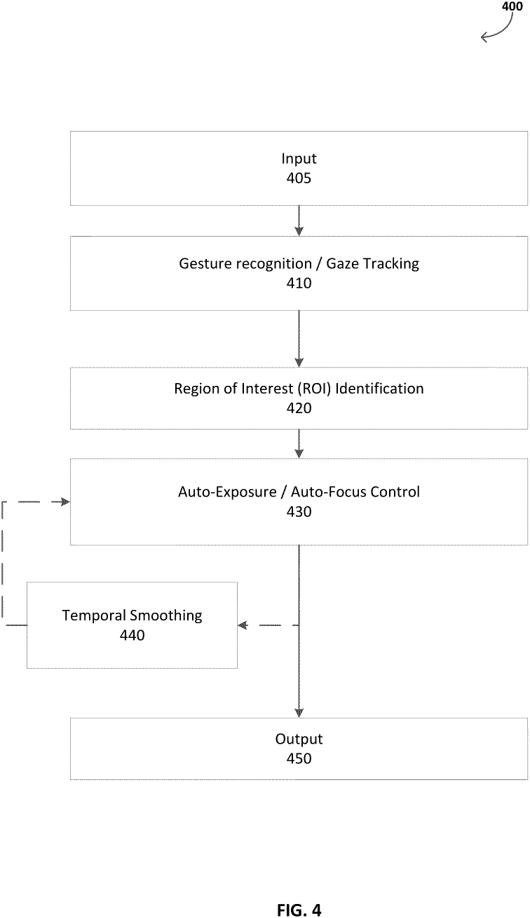

FIG. 4 illustrates an example image adjustment operation 400 in accordance with exemplary embodiments of the present disclosure. A device (e.g., an AR device (e.g., AR system 600 of FIG. 6)) in accordance with exemplary embodiments may receive input 405, which may be one or more images indicative of a scene. The scene may be a user’s view (e.g., viewpoint) of the device, for example, and may be captured by and come from an imaging module, such as for example a camera (e.g., front camera 616 of FIG. 6), associated with the device. The device may receive information indicative of gesture recognition and/or gaze tracking 410, as described herein. For example, information received by the device from a second camera (e.g., an inward facing camera (e.g., camera 618 of FIG. 6)) tracking a user’s eyes may provide gaze tracking information. The gaze tracking information may identify where the user is looking. Additionally, the gaze tracking information may be associated with a length of time the user is staring at an area or object, an eye movement path of the user, a region that the user is looking towards, and/or the like.

One or more outward facing cameras, which may include the imaging module and/or a camera capturing images indicative of a scene, may identify one or more gestures, as described herein. For example, in addition to capturing the scene, the one or more imaging modules and/or cameras may identify a hand, device, or other object or movement indicative of a gesture in the field of view of the scene. For purposes of illustration and not of limitation, gestures may include framing, pinching, pointing, circling, or any of a plurality of user movements, and shapes formed by the user in the field of view of a scene of a captured image. In some exemplary embodiments, an object, such as a pointer, or other item that may be identified and/or associated with an AR device, may be recognized by the imaging module, associated with a gesture, and subsequently used to identify one or more objects or regions of interest. It may be appreciated that a plurality of objects, gestures, shapes, and methods may be implemented to identify a gesture intended to identify one or more objects and/or regions captured by the imaging module and/or camera.

Accordingly, the gesture recognition and/or gaze tracking information 410 detected by a device (e.g., an AR device) may assist in identifying the region of interest 410. The region of interest (ROI) identification 420 may be detected by one or more cameras, as described herein. The cameras may include outward and inward-facing cameras, such as an inward-facing camera to track a user’s eyes, and an outward-facing camera to identify/capture the scene or view which the user sees. The ROI identification 420 mechanism may synchronize the user’s eyes and/or eye movements with the scene images captured by the outward-facing camera.

In various exemplary embodiments, synchronization may utilize machine-learning techniques to track user eye movements and may associate the eye movements with intended actions, viewed regions, and/or the like. Various exemplary embodiments may utilize one or more object-recognition technologies and software to identify potential regions of interest in outward-facing cameras, and/or certain eye movements, changes, and actions indicative of where or towards what a user is looking. For example, synchronization techniques may assist in learning user and/or eye behaviors, such as lengths of time a user’s eye remains in a position, in order to indicate that a user is looking, and/or intending to look, at an object. Other eye movements, or periods of time may additionally be utilized to indicate when a user is merely observing a scene and may not intend to focus on a particular region or object. Synchronized with optional object-recognition technologies, systems and methods of the exemplary embodiments may determine potential objects and/or regions of interest. Such information may be combined with additional eye data, image data, and/or other information to accurately identify a region of interest.

In some exemplary embodiments, one or more cameras may identify user gestures as objects of interests, for purposes of performing ROI identification 420 operations. As described herein, different gestures, which may include pinching, pointing, framing, and directional indications, among others, may be identifiable objects captured by an outward-facing camera. The outward-facing camera may synchronize the gesture information with other objects and/or regions in the surrounding scenery of an image.

Accordingly, when exemplary embodiments determine an object or region of interest 420, the one or more cameras may implement one or more camera features, such as an auto-exposure and/or auto-focus control 430. Such operations may be aligned with camera-control features executed on physical cameras and/or smart devices. For example, instead of a user having to tap on an area of interest on a camera or smart device display, the region of interest identification 420 may be utilized by a device (e.g., AR device) to provide the information to initiate a camera action (e.g., auto-focus) that may otherwise correspond to the physical contact by the user with the display screen or camera to perform the same camera action (e.g., manual selection of a focus control). For example, in an instance in which a user views/looks at a region of interest in the field of view of a camera associated with a device (e.g., an AR device) for a predetermined time period such may cause the device to automatically focus the region of interest. In some example embodiments, the predetermined time period may be associated with a latency of a number of image frames. For purposes of illustration and not of limitation, the predetermined time period may be associated with 223 image frames. In some exemplary embodiments, the predetermined time period may be associated with any suitable number of image frames. While auto-focus and auto-exposure controls are described herein, it may be appreciated that a range of other camera actions and/or settings adjustments may result from implementing the region of interest identification 420 operations. Such actions and settings may be defined manually (e.g., through user input and settings), adaptively, automatically, and/or pre-set, depending on one or more device (e.g., AR device) configurations.

The camera control operations, such as the auto-exposure and/or auto-focus controls 430, may optionally utilize a smoothing technique, such as a stabilizing operation 440, such as a temporal smoothing operation or another camera control operation that may benefit from scene content awareness. Stabilizing operation 440, e.g., temporal smoothing operations, may address and minimize flickering, acting, e.g., as a stabilizer for auto-exposure/auto-focus operations. In examples, auto-exposure/auto-focus may require stabilization due to the possible motion of the camera and/or eye movement. In such cases, temporal smoothing may be implemented. If temporal smoothing is not implemented, auto-exposure may quickly turn higher or lower (i.e., flicker), and/or auto-focus may keep moving and may have difficulty settling. Such processes may be repeated, based on the desired camera effects, filters, and/or the like. Subsequently, an output 450 image and/or video clip may be output by the device and utilized for one or more subsequent operations. The output 450 image and/or video clip may have auto-exposure, auto-focus and temporal smoothing features applied. In some exemplary embodiments, temporal smoothing may be utilized for image enhancement such as, for example, using image brackets to generate high dynamic range (HDR)/low light images. Image bracketing may comprise capturing a plurality of images using various camera settings. In some other exemplary embodiments, temporal smoothing may be utilized for temporal image stabilization, for example, to improve a field of view(s) to center around a region-of-interest(s).

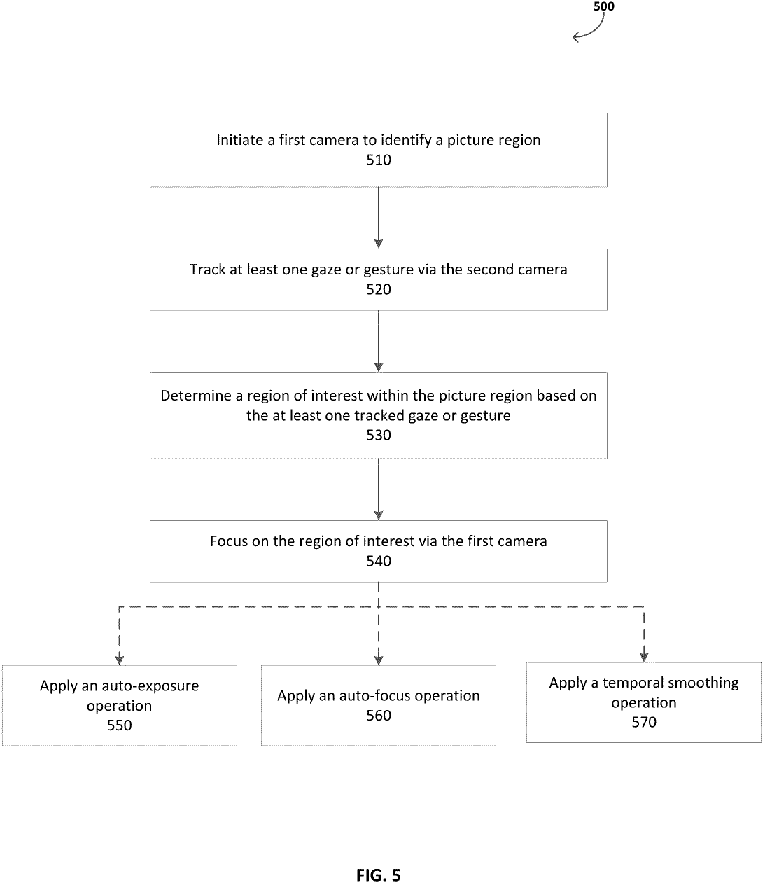

FIG. 5 illustrates a focusing operation 500 in accordance with exemplary embodiments of the present disclosure. In some exemplary embodiments, which may include AR devices, such as a headset or head-mounted device, systems and methods may initiate a first camera to identify a picture region 510. As described herein, the picture region may be captured by an outward facing camera, which provides a view of the scene to be captured. As one example, an outward-facing camera on an AR device may provide a view that is similar and/or substantially the same as the view that the user sees while wearing the AR device.

The AR device (e.g., AR system 600) of the exemplary embodiments may further track at least one gaze and/or gesture via a second camera 520. In some example embodiments, an inward-facing camera, e.g., on the head-mounted AR device, may capture the user’s eyes, and accordingly may track the user’s gaze. In other example embodiments an outward-facing camera, which may be the same as the first camera or a separate/different camera from the first camera, may capture images identifying at least one gesture or indication. In some example embodiments, a third camera may be configured to track at least one of a gaze and/or gesture. Some cameras of the exemplary embodiments may provide image information related to both the picture region, the gaze and/or gesture.

As described herein, the gesture may include, but are not limited to, a hand motion comprising one or more of a directional indication, a pinching indication, a framing indication, a pointing indication, swiping motion, and/or the like. The hand motions may utilize one or more fingers, finger movements, and/or finger motions associated with the gesture.

Based on the at least one tracked gaze and/or gesture, AR devices of exemplary embodiments may determine a region of interest within the picture region 530. Some exemplary embodiments may utilize auditory noises, such as a verbal confirmation, to confirm a selection of a region of interest by an AR device. In other exemplary embodiments, a manual confirmation, such as a tap on a headset, device, object, etc., may confirm a selection to identify a region of interest by an AR device. In some example embodiments, the region of interest identifies one or more objects of interest.

In various exemplary embodiments, the region of interest determination may utilize one or more object recognition and/or synchronization techniques, as described herein to relate and/or coordinate the tracked gaze and/or gesture with the picture region. For example, exemplary embodiments may apply one or more rules to assist in the region of interest determination. Examples of rules may include a period of time (e.g., a predetermined period of time) when the at least one gaze and/or gesture is held/maintained by the user. For purposes of illustration and not of limitation, the period of time may be 0.5 seconds, 1 second, 1.5 seconds, 2 seconds, and/or more or less time. The period of time may be adjusted based on one or more of system and/or device settings, a manual setting, a learned setting, e.g., based on user behavior and learned eye movements, and/or a combination of each of the above.

When the region of interest is determined, the AR devices of the exemplary embodiments may then focus on the region of interest via the first camera 540. As discussed above, the first camera may provide image information regarding a picture region. The picture region may be a scene that the user sees, and the image information may be used for one or more device operations including, but not limited to, image capturing (e.g., taking a picture), informational purposes, integrations with one or more applications or operations on the artificial reality device, and/or the like.

Focusing on the region of interest 540 may optionally comprise one or more operations that include, but are not limited to, applying an auto-exposure operation 550, applying an auto-focus operation 560, and/or applying a stabilizing operation 570, e.g., a temporal smoothing operation. The optional operations may relate to one or more camera settings and/or operations, similar to those which a user may manually adjust, apply, and/or otherwise implement when using a camera.

Accordingly, techniques in accordance with the exemplary embodiments may enable efficient and improved image capturing techniques on devices, such as AR devices, headsets, and hands-free devices. By utilizing the exemplary embodiments, users may initiate device operations with improved ease, and hands-free operations.

In an example, as applied to a head-mounted AR device, a user may initiate a camera to capture the scene being viewed by the user. Rather than using a manually-controlling camera, a user wearing the AR device, may simply look at the desired scene to be captured by a camera of the AR device. As discussed with respect to FIGS. 1A, 1B, 2A, 2B, 3A, 3C, certain objects and/or regions of interest may be identified and focused on, based on detected gestures, or by simply looking at the object or region of interest. In various exemplary embodiments, other camera actions, such as zooming in and/or zooming out may be controlled based on user gestures, such as pinching, swiping, pointing, and/or the like detected in the scene of an image. Various auditory and/or verbal cues may be incorporated as well, to further identify, refine, and determine an intended region of interest. Accordingly, an image or scene may be easily and efficiently captured, and optimization techniques, such auto-focusing techniques, auto-exposure operations, and/or stabilizing operations or any other camera control operation that may benefit from scene content awareness (e.g., temporal smoothing operations) may be (e.g., automatically) applied on a captured desired image. The captured desired image may indicate any desired regions of interest highlighted, through the one or more applied optimization operations.

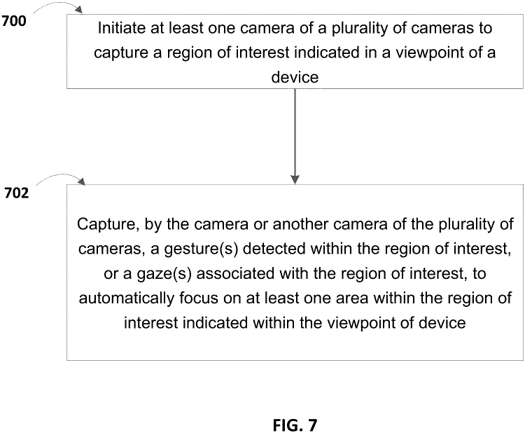

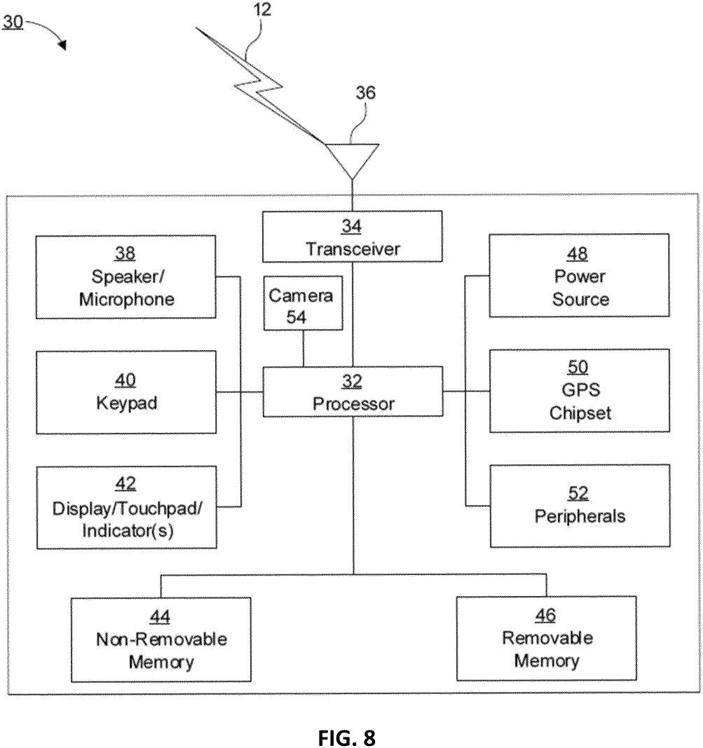

FIG. 6 illustrates an example artificial reality system 600. The artificial reality system 600 may include a head-mounted display (HMD) 610 (e.g., glasses) comprising a frame 612, one or more displays 614, and a computing device 608 (also referred to herein as computer 608). The displays 614 may be transparent or translucent allowing a user wearing the HMD 610 to look through the displays 614 to see the real world and displaying visual artificial reality content to the user at the same time. The HMD 610 may include an audio device 606 (e.g., speaker/microphone 38 of FIG. 8) that may provide audio artificial reality content to users. The HMD 610 may include one or more cameras 616, 618 (also referred to herein as imaging modules 616, 618) which may capture images and/or videos of environments. In one example embodiment, the HMD 610 may include a camera 618 which may be a rear-facing camera tracking movement and/or gaze of a user’s eyes. One of the cameras 616 may be a forward-facing camera capturing images and/or videos of the environment that a user wearing the HMD 610 may view. The HMD 610 may include an eye tracking system to track the vergence movement of the user wearing the HMD 610. In one example embodiment, the camera 618 may be the eye tracking system. The HMD 610 may include a microphone of the audio device 606 to capture voice input from the user. The artificial reality system 600 may further include a controller (e.g., processor 32 of FIG. 8) comprising a trackpad and one or more buttons. The controller may receive inputs from users and relay the inputs to the computing device 608. The controller may also provide haptic feedback to users. The computing device 608 may be connected to the HMD 610 and the controller through cables or wireless connections. The computing device 608 may control the HMD 610 and the controller to provide the artificial/augmented reality content to and receive inputs from one or more users. In some example embodiments, the controller (e.g., processor 32 of FIG. 7) may be a standalone controller or integrated within the HMD 610. The computing device 608 may be a standalone host computer device, an on-board computer device integrated with the HMD 610, a mobile device, or any other hardware platform capable of providing artificial reality content to and receiving inputs from users. In some exemplary embodiments, HMD 610 may include an artificial reality system/virtual reality system.

FIG. 7 illustrates an exemplary process according to an exemplary embodiment. At operation 700, a device (e.g., AR system 600) may initiate at least one camera (e.g., camera 616) of a plurality of cameras to capture a region of interest indicated in a viewpoint of the device.

At operation 702, a device (e.g., AR system 600) may capture, by the at least one camera (e.g., camera 616) or another camera (e.g., camera 618) of the plurality of cameras, at least one gesture detected within the region of interest, or at least one gaze associated with the region of interest, to automatically focus on at least one area within the region of interest indicated within the viewpoint of the device. In some example embodiments, the camera 616 may capture the gesture(s) detected within the region of interest. In some other example embodiments, the camera 618 may detect the gaze(s) associated with the region of interest.

The device (e.g., AR system 600) may automatically focus by applying at least one of an auto-exposure operation, an auto-focus operation, or a stabilizing operation. The another camera may perform the automatically focus, based on the gaze, in an instance in which one or more eyes of a user focuses on the at least one area for a predetermined time period.

In some example embodiments, the device may automatically focus by: determining a relationship between the gaze or the gesture and the region of interest; identifying the at least one area based on the relationship; and receiving, based on the relationship, an indication of a selection of the at least one area. The relationship may indicate at least one of an eye direction in relation to the at least one area or a gesture in relation to the at least one area. The indication of the selection may be associated with a predetermined time period associated with a time that the gaze is determined to track the at least one area.

In some example embodiments, the automatic-focus operation may include moving a viewpoint of the device to focus on the at least one area or zoom in on the at least one area within the viewpoint. In some other exemplary embodiments, the auto-exposure operation may include at least one of automatically setting an optimal exposure of the at least one camara or the another camera when capturing an image of the focused at least one area, a lighting condition of the at least one camera or the another camera when capturing the image, a shutter speed of the at least one camera or the another camera when capturing the image, or adjusting at least one aperture of the at least one camera or the another camera when capturing the image.

The stabilizing operation may include at least one of automatically adjusting brightness associated with the at least one area or at least one blur associated with the at least one area.

FIG. 8 illustrates a block diagram of an exemplary hardware/software architecture of user equipment (UE) 30. As shown in FIG. 8, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an exemplary embodiment, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another embodiment, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

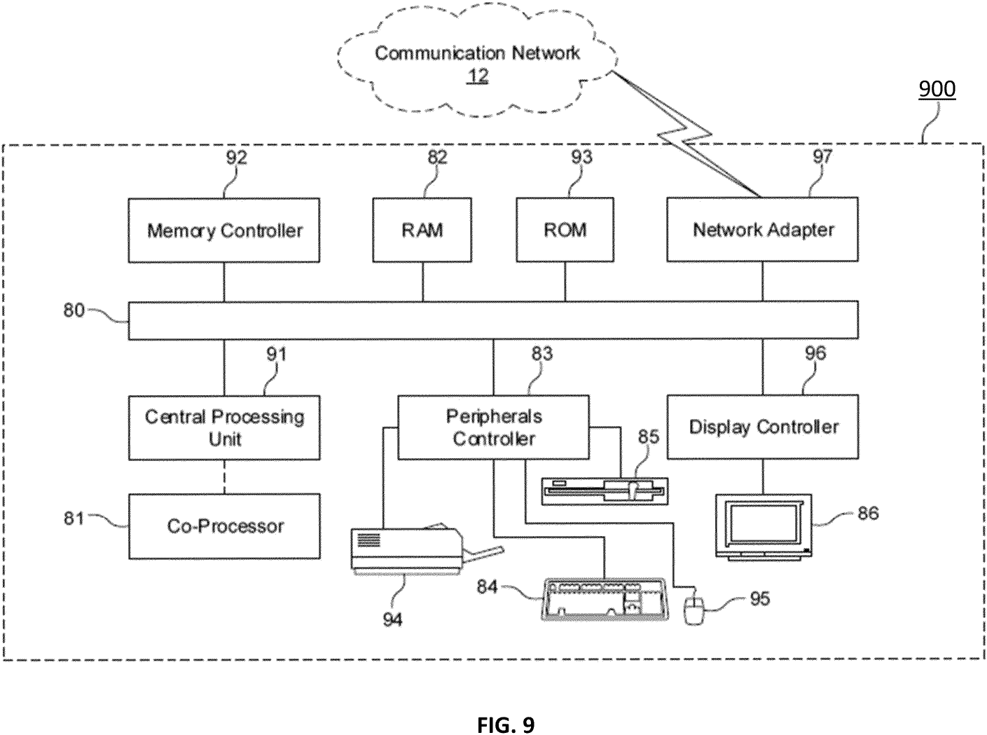

FIG. 9 is a block diagram of an exemplary computing system 900 which may also be used to implement components of the system or be part of the UE 30. The computing system 900 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 900 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer’s main data-transfer path, system bus 80. Such a system bus connects the components in computing system 900 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process’s virtual address space unless memory sharing between the processes has been set up.

In addition, computing system 900 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 900. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 900 may contain communication circuitry, such as for example a network adaptor 97, that may be used to connect computing system 900 to an external communications network, such as network 12 of FIG. 8, to enable the computing system 900 to communicate with other nodes (e.g., UE 30) of the network.

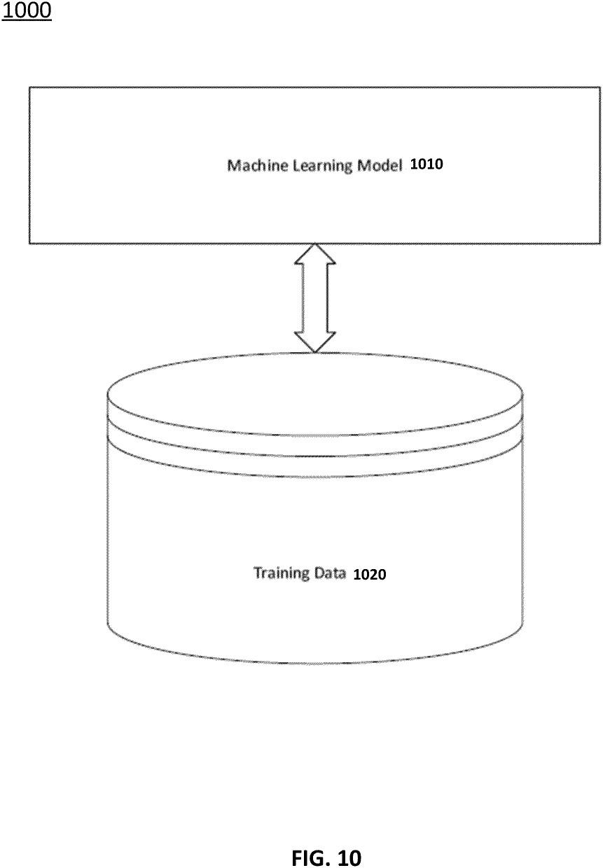

FIG. 10 illustrates a framework 1000 employed by a software application (e.g., algorithm) for evaluating attributes of a gesture. The framework 1000 may be hosted remotely. Alternatively, the framework 1000 may reside within the UE 30 shown in FIG. 8 and/or be processed by the computing system 900 shown in FIG. 9. The machine learning model 1010 is operably coupled to the stored training data in a database 1020.

In an exemplary embodiment, the training data 1020 may include attributes of thousands of objects. For example, the object may be a hand position. Attributes may include, but are not limited to, the size, shape, orientation, position of a hand, etc. The training data 1020 employed by the machine learning model 1010 may be fixed or updated periodically. Alternatively, the training data 1020 may be updated in real-time based upon the evaluations performed by the machine learning model 1010 in a non-training mode. This is illustrated by the double-sided arrow connecting the machine learning model 1010 and stored training data 1020.

In operation, the machine learning model 1010 may evaluate attributes of images/videos obtained by hardware (e.g., of the AR system 600, UE 30, etc.). For example, the camera 616 of AR system 600 and/or camera 54 of the UE 30 shown in FIG. 8 senses and captures an image/video, such as for example hand positions, hand movements (e.g., gestures) and/or other objects, appearing in or around a bounding box of a software application. The attributes of the captured image (e.g., captured image of a gesture(s)) are then compared with respective attributes of stored training data 1020 (e.g., prestored training gestures). The likelihood of similarity between each of the obtained attributes (e.g., of the captured image of a gesture(s)) and the stored training data 1020 (e.g., prestored training gestures) is given a confidence score. In one exemplary embodiment, if the confidence score exceeds a predetermined threshold, the attribute is included in an image description (e.g., thumbs up gesture, thumbs down gesture, etc.) that is ultimately communicated to the user via a user interface of a computing device (e.g., UE 30, computing system 800). In another exemplary embodiment, the description may include a certain number of attributes which exceed a predetermined threshold to share with the user. The sensitivity of sharing more or less attributes may be customized based upon the needs of the particular user.

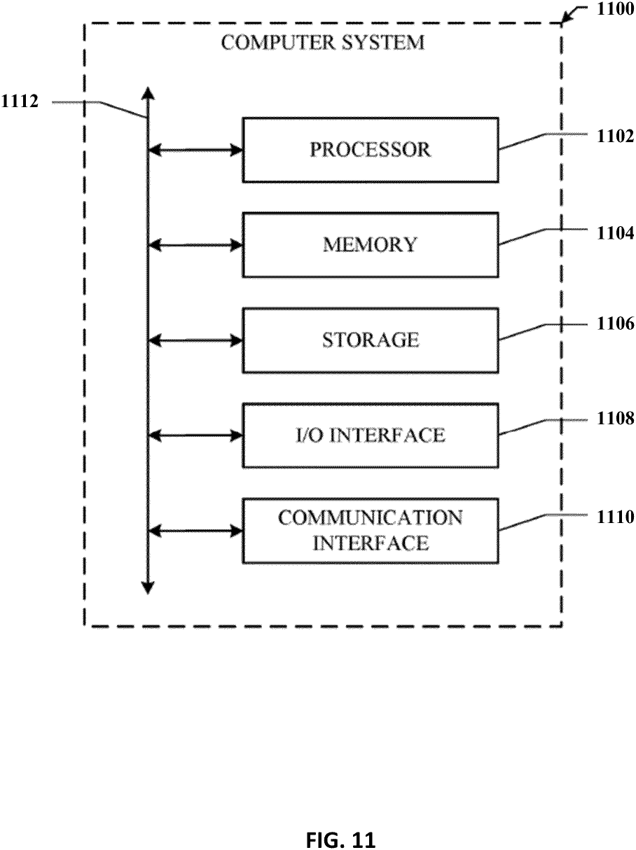

FIG. 11 illustrates an example computer system 1100. In exemplary embodiments, one or more computer systems 1100 perform one or more steps of one or more methods described or illustrated herein. In particular embodiments, one or more computer systems 1100 provide functionality described or illustrated herein. In exemplary embodiments, software running on one or more computer systems 1100 performs one or more steps of one or more methods described or illustrated herein or provides functionality described or illustrated herein. Exemplary embodiments include one or more portions of one or more computer systems 1100. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example, and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In exemplary embodiments, computer system 1100 includes a processor 1102, memory 1104, storage 1106, an input/output (I/O) interface 1008, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In exemplary embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1002 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In exemplary embodiments, memory 1104 includes main memory for storing instructions for processor 1002 to execute or data for processor 1102 to operate on. As an example and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In exemplary embodiments, one or more memory management units (MMUs) reside between processor 1102 and memory 1104 and facilitate accesses to memory 1004 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In exemplary embodiments, storage 1106 includes mass storage for data or instructions. As an example, and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In exemplary embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In exemplary embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In exemplary embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed:

1. A device comprising:
a plurality of cameras; and
at least one processor and a non-transitory memory including computer-executable instructions, which when executed by the processor, cause the device to at least:
initiate at least one camera of the plurality of cameras to capture a region of interest indicated in a viewpoint of the device; and
capture, by the at least one camera or another camera of the plurality of cameras, at least one gesture detected within the region of interest, or at least one gaze associated with the region of interest, to automatically focus on at least one area within the region of interest indicated within the viewpoint of the device.

2. The device of claim 1, wherein the instructions, which when executed by the processor, further cause the device to at least:
perform the automatically focus by applying at least one of an auto-exposure operation, an auto-focus operation, or a stabilizing operation.

3. The device of claim 2, wherein the automatic-focus operation comprises moving a viewpoint of the device to focus on the at least one area or zoom in on the at least one area within the viewpoint.

4. The device of claim 2, wherein the auto-exposure operation comprises at least one of automatically setting an optimal exposure of the at least one camara or the another camera when capturing an image of the focused at least one area, a lighting condition of the at least one camera or the another camera when capturing the image, a shutter speed of the at least one camera or the another camera when capturing the image, or adjusting at least one aperture of the at least one camera or the another camera when capturing the image.

5. The device of claim 2, wherein the stabilizing operation comprises at least one of automatically adjusting brightness associated with the at least one area or at least one blur associated with the at least one area.

6. The device of claim 1, wherein the at least one camera captures the at least one gesture detected within the region of interest.

7. The device of claim 1, wherein the another camera captures the at least one gaze associated with the region of interest.

8. The device of claim 1, wherein the another camera captures the at least one gaze by tracking one or more eyes of a user viewing the region of interest.

9. The device of claim 1, wherein the another camera performs the automatically focus, based on the gaze, in an instance in which the one or more eyes of the user focuses on the at least one area for a predetermined time period.

10. The device of claim 9, wherein the predetermined time period is associated with a latency of a number of image frames.

11. The device of claim 1, wherein the instructions, which when executed by the processor, further cause the device to automatically focus by:
determining a relationship between the at least one gaze or the at least one gesture and the region of interest;
identifying the at least one area based on the relationship; and
receiving, based on the relationship, an indication of a selection of the at least one area.

12. The device of claim 11, wherein the relationship indicates at least one of an eye direction in relation to the at least one area or a gesture in relation to the at least one area.

13. The device of claim 11, wherein the indication of the selection is associated with a predetermined time period associated with a time that the gaze is determined to track the at least one area.

14. The device of claim 13, wherein the predetermined time period comprises one or more seconds.

15. The device of claim 11, wherein the indication of the selection comprises at least one of a verbal command or a manual command detected by the device.

16. The device of claim 15, wherein the verbal command comprises an audio command of a user to select the at least one area and wherein the manual command comprises a tap of a finger of a user associated with the at least one area within the viewpoint of the device.

17. The device of claim 1, wherein the at least gesture comprises a hand motion comprising at least one of a directional indication, a pinching indication, or a framing indication.

18. The device of claim 1, wherein the at least one gesture comprises one or more detected motions of a hand of a user, associated with the at least one area, captured by the at least one camera, in the viewpoint of the device.

19. A computer-readable medium storing instructions that, when executed, cause:
initiating at least one camera of a plurality of cameras of a device to capture a region of interest indicated in a viewpoint of the device; and
capturing, by the at least one camera or another camera of the plurality of cameras, at least one gesture detected within the region of interest, or at least one gaze associated with the region of interest, to automatically focus on at least one area within the region of interest indicated within the viewpoint of the device.

20. A method comprising:
initiating a first camera of a device to identify a picture region;
tracking at least one gaze via a second camera or at least one gesture via the first camera of the device;
determining a region of interest within the picture region based on the tracked at least one gaze or the at least one gesture; and
focusing on the region of interest via the first camera.
